(19) United States
(12) Patent Application Publication
(10) Pub. No.: US 2009/0220371 A1
(43) Pub. Date: Sep. 3, 2009

(54) METHODS FOR DIMENSIONAL RESTORATION OF ROOTS TYPE BLOWER ROTORS, RESTORED ROTORS, AND APPARATUS HAVING RESTORED ROTOR

(76) Inventors: Alistair Jeffrey Smith, Simpsonville, SC (US); Stephen Smith, Erie, PA (US)

Correspondence Address: GENERAL ELECTRIC COMPANY, GE AVIATION, ONE NEUMANN WAY MD H17, CINCINNATI, OH, 45215, US

(21) Appl. No.: 12/040,207

(22) Filed: Feb. 29, 2008

(51) Int. Cl. B23P 6/00; F04C 18/18; F04C 27/00

(52) U.S. Cl. 418/206.6; 418/196; 29/402.03; 29/402.04; 29/402.18

(57) ABSTRACT

Method includes applying additive material to a pre-selected region of a rotor for use in a Roots type blower assembly. The additive material restores structural dimension to provide measured rotor-to-rotor clearance and/or rotor-to-case clearance within the predetermined clearance range. The additive material may be an epoxy paint material or a plating material. The method includes measuring the clearances, preparing the rotor surface, applying the additive material, and re-measuring the clearance. The restored rotor may be returned to service, for example, in a locomotive diesel. The disclosure also provides a restored rotor including at least one region comprising the additive material. Additionally, the disclosure provides an apparatus including a dimensionally restored rotor.

### BACKGROUND OF THE INVENTION

This invention relates generally to Roots type blowers used in diesel locomotives, and more specifically to dimensional restoration of a rotor for use in a Roots type blower motor assembly.

No matter how well a locomotive engine Roots type blower is constructed, over time and use, parts will require replacing and/or refurbishing. When a locomotive engine Roots blower is being overhauled, the rotor-to-rotor clearance and the rotor-to-case clearance are measured. The blower is then disassembled, cleaned, and inspected for surface defects on the rotor or case surface. In some instances, the found defects may be removed through blending. The blower is then re-assembled and the clearances measured again. If the clearances exceed pre-established limits, the Roots blower is rejected for re-use in the diesel engine. A new rotor set may be inserted into the overhauled Roots blower, and the Roots blower returned to service. However, there are currently no methods for restoring the rotors that exhibit under-limit rotor-to-rotor or rotor-to-case clearances.

Accordingly, it would be desirable to have a cost-effective rotor restoration method to eliminate the necessity for installation of a new rotor set.

### BRIEF DESCRIPTION OF THE INVENTION

The above-mentioned need or needs may be met by exemplary embodiments which provide a method including measuring at least one of a rotor-to-rotor clearance or a rotor-to-case clearance of a Roots type blower motor assembly including at least first and second meshing lobed rotors rotatably operable within a rotor case; locating at least one region on at least one of the first or second rotors having an insufficient dimension wherein at least one of the measured rotor-to-rotor clearance or the measured rotor-to-case clearance exceeds a predetermined maximum value; and applying additive material at the at least one region.

In another embodiment, a method includes measuring at least one of a rotor-to-rotor clearance or a rotor-to-case clearance of a Roots type blower motor assembly including at least first and second meshing lobed rotors rotatably operable within a rotor case; locating at least one region on at least one of the first or second rotors having an insufficient dimension wherein at least one of the measured rotor-to-rotor clearance or the measured rotor-to-case clearance exceeds a predetermined maximum value; preparing the at least one of the first or second rotors for reception of the additive material at the at least one region; and applying additive material at the at least one region, wherein the additive material is at least one member of the group consisting of an epoxy paint and a metallic plating material, wherein the additive material is applied in an amount sufficient to provide a re-measured rotor-to-rotor clearance or a re-measured rotor-to-case clearance not exceeding the predetermined maximum value.

In another embodiment there is provided an apparatus comprising a restored Roots type blower motor assembly including at least first and second meshing lobed rotors being rotatably operable within a rotor case, wherein at least one of the first and second rotors includes at least one region including additive material, wherein absent the additive material at least one of a rotor-to-rotor clearance or a rotor-to-case clearance exceeds a predetermined maximum value, and with the additive material, the at least one of the rotor-to-rotor clearance or the rotor-to-case clearance is less than or equal to the predetermined maximum value.

In another embodiment there is provided an article comprising a first lobed rotor of a Roots type blower motor assembly being adapted for assembled operation with an associated second lobed rotor within a rotor case. The first lobed rotor includes at least one region including additive material, wherein absent the additive material the at least one region comprises an insufficient dimension for assembled operation, and with the additive material, the at least one region of the first lobed rotor comprises a sufficient dimension for assembled operation.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 is a cross-sectional view of a Roots type rotary blower assembly.

FIG. 1A illustrates a rotor-to-rotor clearance.

FIG. 1B illustrates a rotor-to-case clearance.

FIG. 2 is a schematic view of left and right rotor/shaft subassemblies illustrating left and right meshing rotors.

FIG. 3 is a schematic view of a rotor having additive material applied thereto.

FIG. 4 provides a flowchart of an exemplary restorative process.

### DETAILED DESCRIPTION OF THE INVENTION

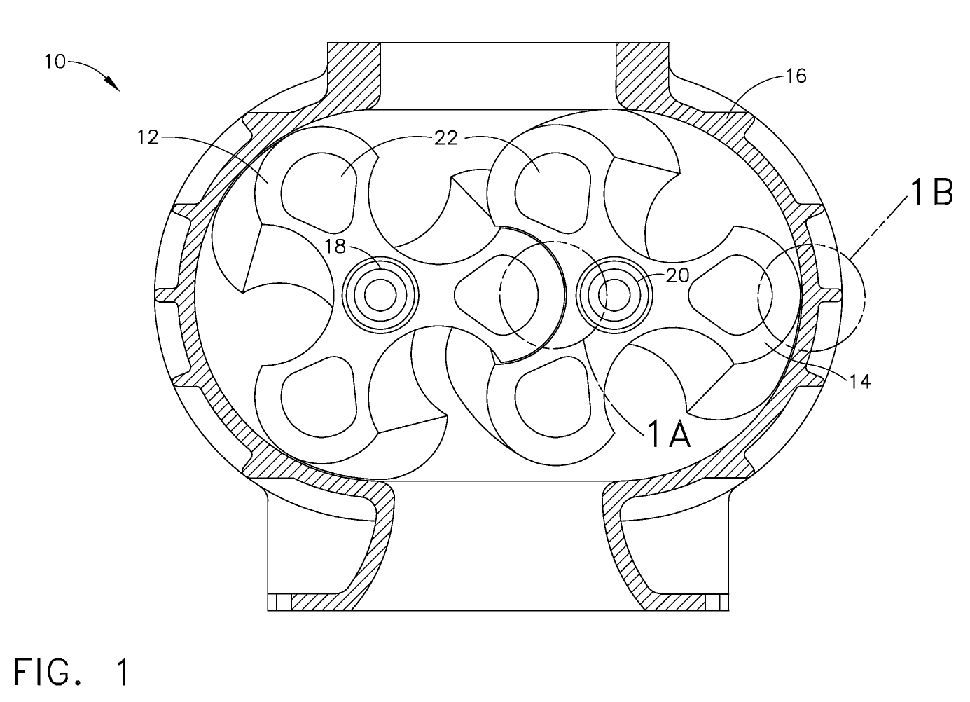

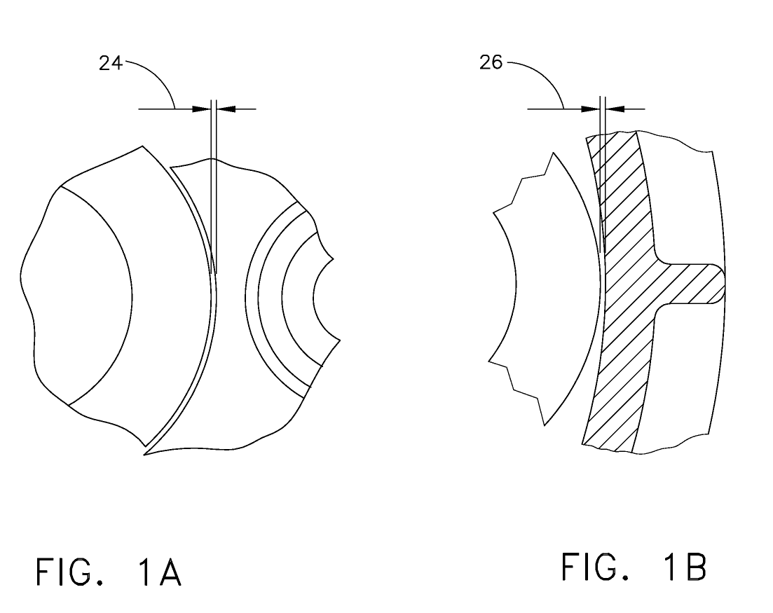

Referring to the drawings wherein identical reference numerals denote the same elements throughout the various views, FIG. 1 shows an exemplary Roots type rotary blower assembly 10. Blower assembly 10 includes a lobed left rotor 12 and a lobed right rotor 14 arranged within a housing or case 16 in meshing relationship, i.e., in close relationship with a mutual 90-degree phase offset. The left and right rotors are carried on respective left and right shafts 18, 20 and rotatable therewith in opposite directions at the same rotational speed. Each rotor and its respective shaft are referred to herein as a rotor/shaft subassembly. The rotors 12, 14 may include hollow chambers 22, although embodiments disclosed herein are equally applicable to both solid and hollow rotors. Rotors 12, 14 are illustrated as having helical lobes, although embodiments disclosed herein are equally applicable to blower assemblies having helical or straight-lobed rotors.

The embodiments disclosed herein are described with particular reference to a Roots type blower assembly having been used in a diesel locomotive, without so limiting the invention. Because the rotors are arranged in rotating meshing relationship within a case, appropriate rotor-to-rotor clearances 24 (FIG. 1A) and rotor-to-case clearances 26 (FIG. 1B) must be provided in the blower assembly. Air leakage through the clearances decreases blower efficiency. Thus, it is desirable to provide a threshold or maximum value for the rotor-to-rotor clearance as well as a maximum value for the rotor-to-case clearance. During use, mechanical interference between rotors or between one or both rotors and the case may occur. Such mechanical interference may abrade or damage the rotor surfaces such that at least at some region of a rotor, the rotor-to-rotor and/or the rotor-to-case clearance exceed the maximum value thereby adversely impacting the efficiency of the blower assembly.

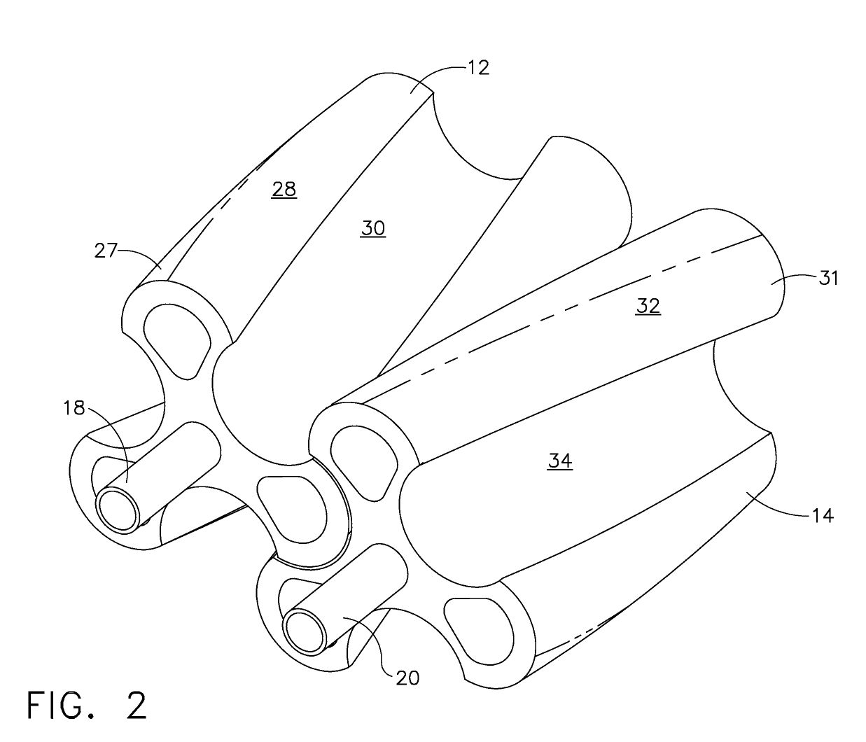

With reference to FIG. 2, each of the lobes 27 of left rotor 12 includes a generally convex surface 28 and a generally concave surface 30. In like manner, each of the lobes 31 of right rotor 14 includes a generally convex surface 32 and a generally concave surface 34. As will be explained in greater detail below, blower assemblies having clearances that exceed the maximum threshold value may be restored by supplying additive material onto the convex surfaces 28, 32.

In the methods disclosed herein, the pair of rotor/shaft subassemblies are disassembled from the blower assembly, but are maintained as a matched set. In other words, during the restoration process, the pair of subassemblies is restored so that the same rotor/shaft subassemblies can be reassembled as a unit in meshed relationship as before.

In an exemplary embodiment, when a Roots type blower assembly 10 requires repair or restoration, i.e., after some time of service, the rotor-to-rotor clearance 24 is measured while the blower assembly is still assembled. Techniques known by those with skill in the art may be utilized to measure the rotor-to-rotor clearance. In one exemplary method, one or more feeler gages, not shown, may be employed. The gages should have adequate calibration schedules as is customary in the art. In an exemplary embodiment, a plurality of axial regions along each lobe is identified for measurement. To measure the rotor-to-rotor clearance, a feeler gage is inserted between the rotors to an adequate depth at the indicated regions to ensure the highest point on the rotors' lobes will contact the gage. The rotors are slowly rotated in their respective operating directions and a clearance measurement is obtained. In an exemplary embodiment, several individual rotor-to-rotor measurements are made and averaged to obtain the rotor-to-rotor clearance.

The rotor-to-rotor clearance is compared to a certain rotor-to-rotor clearance standard usually given in terms of a range between allowable minimum and maximum clearances. For example, the acceptable rotor-to-rotor clearance may fall within the range of 0.010 inches (0.25 mm) and 0.022 inches (0.56 mm). Of course, other applicable standards may require other clearance values.

If a particular region of a rotor is identified as having an insufficient dimension causing the rotor-to-rotor clearance to exceed the maximum, restorative measures can be taken as described more fully below.

In a similar manner, a rotor-to-case measurement may be obtained by utilizing techniques known by those with skill in the art. For example, a feeler gage, not shown, may be inserted between the rotor and the case at designated positions to obtain the rotor-to-case clearance. In an exemplary embodiment, several individual measurements are made and averaged to obtain the rotor-to-case clearance measurement. An exemplary rotor-to-case standard may call for measurements within a range of 0.012 inches (0.30 mm) and 0.020 inches (0.51 mm). As with the rotor-to-rotor clearances, other applicable standards may require different ranges for minimum and maximum clearance values. Exemplary embodiments disclosed herein are particularly directed to decreasing rotor-to-rotor and/or rotor-to-case clearances that exceed the maximum value of an applicable standard.

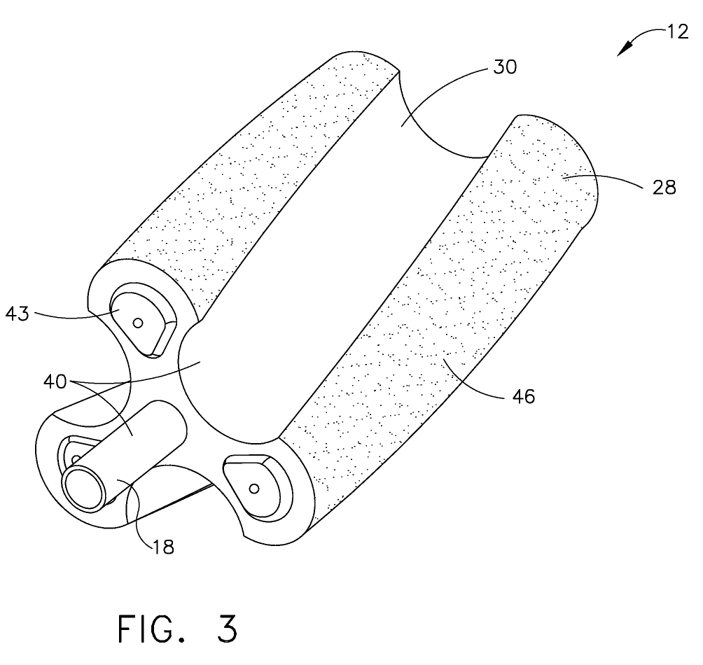

With reference to FIG. 3, wherein only the left rotor/shaft subassembly is illustrated, the measured rotor-to-rotor clearance or rotor-to-case clearance is used to identify one or more regions on the rotor having an insufficient dimension, resulting in the over-maximum clearance. As shown in FIG. 3, the rotor is prepared for application of additive material to one or more identified regions of the rotor. Portions of the rotor/shaft subassembly that should not be exposed to the additive material are masked by appropriate masking material 40. Additionally, if the lobes include hollow spaces 22, suitable plugs 43 may be inserted therein.

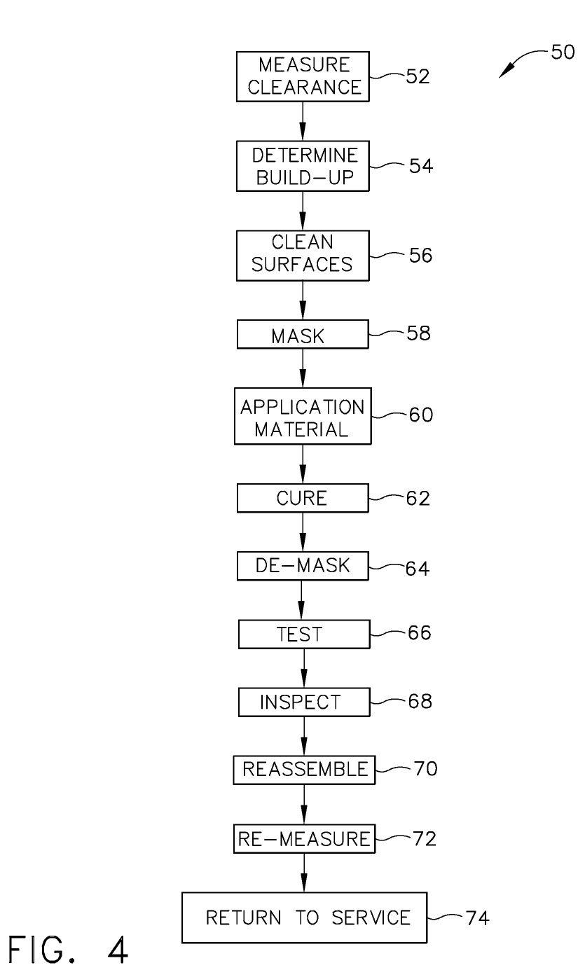

In an exemplary embodiment, a method is provided for restoring the rotor-to-rotor clearance and/or the rotor-to-case clearance of a Roots type blower assembly. FIG. 4 shows a flowchart for an exemplary restorative process. In an exemplary embodiment, while the blower assembly is assembled, at least one of the rotor-to-rotor clearance or the rotor-to-case clearance is measured (step 52). As noted above, the clearance measurement may represent an average of several individual measurements. The clearance measurement is used to determine at least one region on the rotor having an insufficient dimension. The amount of insufficiency, in other words, the amount of build-up required, can be determined by a comparison of the clearance measurement with the applicable standard (step 54).

In an exemplary embodiment, the surfaces to be built-up are cleaned in conventional manner (step 56). For example, the surfaces may be cleaned with a suitable solvent such as methyl ethyl ketone (MEK). The surface may also be vapor degreased to remove any oil or surface contaminants.

In an exemplary embodiment, the portions of the rotor/shaft subassembly to be protected are masked (step 58), and hollow chambers or other holes are plugged. The surface may be subjected to grit blasting using, for example, 150-mesh aluminum oxide at 40 psi (27.6 N/cm²). Prior to application of any additive material, the concave surfaces are masked, for example with vinyl tape, so that a clean line can be maintained between the concave and convex surfaces. If necessary, the end faces of the rotor may be masked as well.

Additive material 46 (see FIG. 3) is then added to the surfaces to be rebuilt (step 60). A currently preferred additive material is POR-15® rust preventive paint available from Por-15 Inc., Morristown, N.J. According to a published material safety data sheet (MSDS), POR-15® rust preventive paint is an isocyanate prepolymer including diphenylmethane diisocyanate (MDI), naphtha petroleum, non-hazardous proprietary ingredients, and various catalysts. It has been discovered that insufficient rotor dimension can be restored by application of this particular additive material. It is envisioned that similar results can be obtained by use of other products. The applied material must be able to provide sufficient structural integrity so that the restored rotor may be returned to service. One desirable feature of this particular product is that it is air-curable at ambient temperature. When using this product, it is advantageous to apply the necessary build-up in thin layers that are air-dried for approximately 30 minutes before a subsequent layer is applied. The application step is repeated until the desired amount of build-up is achieved. To ensure an accurate thickness reading, it may be necessary to allow the additive material to cure for several hours or overnight. In an exemplary embodiment, if insufficient dimensional restoration is identified, the previously coated region may be abraded or scuffed and solvent cleaned to prepare the surface for additional additive material.

Although the currently preferred material (POR-15 Paint) is commercially available, it is believed that use of the material for structural restoration, particularly on a Roots type blower rotor is previously unknown.

In an exemplary embodiment, after sufficient curing (air-drying) time (Step 62), the rotor is de-masked (Step 64). The additive material may be peel tested (Step 66) in accordance with a suitable standard to test the adhesion of the additive material to the underlying substrate. An exemplary adhesion test is ASTM D3359. In an alternative method, the additive material may be peel tested prior to de-masking.

In an exemplary embodiment, the rotors are inspected (Step 68) to ensure adequate coverage of the desired areas without overspray on the rotor tips. Following the successful addition of the additive material, the matched left and right rotor/shaft subassemblies are re-assembled (Step 70). The rotor-to-rotor and rotor-to-case clearances are re-measured and compared to the applicable standards (Step 72). If the measured clearances are within the applicable standards, the re-assembled blower assembly may be returned to service (Step 74). In an exemplary embodiment, certain of the above-recited steps may be repeated as necessary to restore adequate rotor-to rotor and rotor-to-case clearances.

In an alternate embodiment, the additive material may be a metallic plating material. In an exemplary embodiment, the additive material includes electroless nickel plating. As with the epoxy paint, the additive material is provided in an amount sufficient for dimensional restoration at one or more predetermined locations on the rotor(s). The rotors are inspected, re-assembled, and re-measured. After successful addition of additive material, the Roots type blower motor may be returned to service. Also, as with the epoxy paint, certain of the method steps may be repeated as necessary to ensure adequate build-up of the additive material.

Thus, a rotor set may be returned to operational service by methods disclosed herein for dimensional restoration of selected portions of one or both rotors. In one exemplary embodiment, the dimensional restoration is achieved by application of an epoxy paint product to the selected portions. In another exemplary embodiment, a metallic plating material is applied to the pre-selected regions. Other additive materials capable of adhering to the rotors and providing structural restoration are envisioned within the scope of this disclosure.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising the steps of:
(a) measuring at least one of a rotor-to-rotor clearance or a rotor-to-case clearance of a Roots type blower motor assembly including at least first and second meshing lobed rotors rotatably operable within a rotor case;
(b) locating at least one region on at least one of the first or second rotors having an insufficient dimension wherein at least one of the measured rotor-to-rotor clearance or the measured rotor-to-case clearance exceeds a predetermined maximum value; and
(c) applying additive material at the at least one region.

2. The method according to claim 1 further comprising, prior to (c):
(d) preparing the at least one of the first or second rotors for reception of the additive material at the at least one region.

3. The method according to claim 1 wherein the additive material is curable, and wherein the method further comprises:
(d) curing the additive material.

4. The method according to claim 1 further comprising, prior to (c):
(d) disassembling the Roots type blower motor assembly.

5. The method according to claim 4 further comprising, subsequent to (c):
(e) reassembling the Roots type blower motor assembly so that the at least first and second rotors are arranged in meshing relationship within the rotor case.

6. The method according to claim 5 further comprising, subsequent to (e):
(f) re-measuring the at least one of the rotor-to-rotor clearance or the rotor-to-case clearance.

7. The method according to claim 6 further comprising:
(g) optionally, repeating any of the steps (a)-(f) until the measured clearance is at or below the predetermined maximum value.

8. The method according to claim 5, wherein the Roots type blower motor assembly has previously been used in a diesel locomotive, wherein the method further comprises, subsequent to (e):
(f) placing the Roots type blower motor assembly into service in the same or another diesel locomotive.

9. The method according to claim 1 wherein in (c), applying additive material includes spraying an epoxy paint onto the at least one region.

10. The method according to claim 1 wherein in (c), applying additive material includes plating the at least one region with a metallic plating material.

11. The method according to claim 4 further comprising:
e) identifying the first and second rotors as a matched set, wherein the matched set is associated with the rotor case.

12. A method comprising the steps of:
(a) measuring at least one of a rotor-to-rotor clearance or a rotor-to-case clearance of a Roots type blower motor assembly including at least first and second meshing lobed rotors rotatably operable within a rotor case;
(b) locating at least one region on at least one of the first or second rotors having an insufficient dimension wherein at least one of the measured rotor-to-rotor clearance or the measured rotor-to-case clearance exceeds a predetermined maximum value;
(c) preparing the at least one of the first or second rotors for reception of additive material at the at least one region;
(d) applying the additive material at the at least one region, wherein the additive material is at least one member of the group consisting of an epoxy paint and a metallic plating material, wherein the additive material is applied in an amount sufficient to provide a re-measured rotor-to-rotor clearance or a re-measured rotor-to-case clearance not exceeding the predetermined maximum value.

13. Apparatus comprising:
a restored Roots type blower motor assembly comprising:
at least first and second meshing lobed rotors being rotatably operable within a rotor case, wherein at least one of the first and second rotors includes at least one region including additive material, wherein absent the additive material at least one of a rotor-to-rotor clearance or a rotor-to-case clearance exceeds a predetermined maximum value, and with the additive material, the at least one of the rotor-to-rotor clearance or the rotor-to-case clearance is less than or equal to the predetermined maximum value.

14. The apparatus according to claim 13 wherein the additive material is at least one member selected from an epoxy paint and a metallic plating material.

15. The apparatus according to claim 14 wherein the selected additive material is an epoxy paint being curable at ambient temperature.

16. The apparatus according to claim 14 wherein the selected additive material is electroless nickel plating material.

17. An article comprising:
a first lobed rotor of a Roots type blower motor assembly being adapted for assembled operation with an associated second lobed rotor within a rotor case, wherein the first lobed rotor includes at least one region including additive material, wherein absent the additive material the at least one region comprises an insufficient dimension for assembled operation, and with the additive material, the at least one region of the first lobed rotor comprises a sufficient dimension for assembled operation.

18. The article according to claim 17 wherein the additive material is at least one member selected from an epoxy paint and a metallic plating material.

19. The article according to claim 18 wherein the selected additive material is an epoxy paint being curable at ambient temperature.

20. The article according to claim 18 wherein the selected additive material is a metallic plating material comprising electroless nickel plating material.
